(19) United States
(12) Patent Application Publication
(10) Pub. No.: US 2001/0004261 A1
(43) Pub. Date: Jun. 21, 2001

(54) Method for creating an image and the like using a parametric curve by operating a computer in a network and method for transmitting the same through the network

(76) Inventors: Yayoi Kambayashi, Tokyo (JP); John Maeda, Lexington, MA (US)

Correspondence Address: Harold C. Wegner, FOLEY & LARDNER, Washington Harbour, 3000 K Street, N.W., Suite 500, Washington, DC, 20007-5109, US

(21) Appl. No.: 09/777,864

(22) Filed: Feb. 7, 2001

Related U.S. Application Data
(63) Continuation of application No. 09/064,782, filed on Apr. 23, 1998, now abandoned.

(51) Int. Cl. G06F 17/00

(52) U.S. Cl. 345/418

(57) ABSTRACT

A creation method and transmission method for images or the like are provided that allow a user to create images, characters, etc. freely by a computer in a network and are capable of transmitting the created image information without imposing a heavy burden on the network and local terminals. Images and characters are created as desired by controlling parametric curves on the network using the JAVA language and by interactively creating parameterized images and characters. Further, the shape, size, quantity, arrangement, orientation, color, etc. of the images and characters are varied as desired by using parameters. The parameterized images and characters are transmitted over the network.

### FIELD OF THE INVENTION

The present invention relates to methods for creating and transmitting an image, a character, and a line drawing by a computer in a network such as a LAN or the Internet.

### BACKGROUND OF THE INVENTION

With the emergence of the Java language, it has become possible to run application programs created with Java, called applets, on network browsers such as Internet browsers. This has made dynamic representations of documents and images possible and added interactivity and expandability to the World Wide Web (WWW). For example, when one has devised a new image format, one can distribute image data together with an applet for decoding the image format so that the new image format can be used on a browser. The JAVA language was developed as a programming language for writing such applets.

However, when, for example, a user wishes to create a card carrying an image and text on it by using the above applet, all that the user can do with the image is to select an image from the menu provided on the browser, and it is not possible for the user to create an image at will. Furthermore, when transmitting such a card over a network, a heavy burden has been imposed on the network.

In view of this, MIME (Multipurpose Internet Mail Extension) has been developed to enable the user to create an image at will and include it for transmission together with text information. However, in the case of MIME, since the image is transmitted in encoded form, the amount of transmitted data increases, which, coupled with the image decoding necessary at the receiving end, places a great burden on the network as well as the local terminals.

As described above, when creating an image on a network, with the conventional known method the user is not able to create an image as he desires. Further, even if the user can create a desired image, transmitting the image information together with text information has imposed a heavy burden on the network as well as on the local terminals.

### SUMMARY OF THE INVENTION

It is, accordingly, an object of the present invention to provide a method for the creation of an image, text, etc., that allows users to create an image and handwritten characters or lines freely by a computer in a network, and also a transmission method that can transmit the created image information, text information, etc. without imposing a heavy burden on the network or local terminals.

To achieve the above object, the present inventor has developed an applet, created with the JAVA language, that allows the creation of an image, a character, or a line drawing by controlling a parametric curve. The user downloads this applet across a network such as the Internet, creates an image, character, etc. by controlling the parametric curve on the network, and transmits the parameterized image, character, etc. over the network.

The parametric curve is a curve such that the coordinate values of each point on the curve are expressed in terms of a single parameter. In the case of a plane curve, for example, the two coordinate values, x and y, of a point on the curve are expressed in terms of a parameter t as

x=x(t), y=y(t)

The position vector of this point is expressed as

P(t)={x(t), y(t)}

The parametric curve has the characteristic that formulas for its representation can be calculated easily even if the curve is rotated and translated. In the case of a closed curve also, there is the advantage that its representation is simple since each point on the curve is determined by a single parameter.

According to the present invention, the user can freely create an image by a computer in a network, and can also freely create a handwritten character and line drawing for transmission. Such images, characters, etc. are created by controlling parametric curves using the JAVA language.

Further, images created using the parametric curve controllable by a computer in the network can be varied in shape, size, quantity, arrangement, orientation, and color by using parameters. Accordingly, the user can create an image by himself in an interactive manner, rather than selecting an existing image from a limited menu, and can transmit it together with a message as a single piece of mail. In the case of characters and the like, the user can draw characters and lines freely by hand by using parametric curves, and can create a message by varying their shape, size, quantity, arrangement, orientation, and color by using parameters, as in the case of images.

For example, using a Bezier curve which is a representative parametric curve, the user can create a base image in an interactive manner, and can create a desired image by freely changing the shape, size, quantity, arrangement, orientation, color, etc. of the base image by using parameters.

Further, instead of creating an image by himself, the user can prepare a parameterized image pattern in advance by controlling the parametric curve using the JAVA language, and can create a base image by selecting a motif from this pattern.

The user can also capture an already created desired image, etc. into a computer in the network, transmit it to the server via the network, converts it into a parameterized pattern by controlling the parametric curve using the JAVA language, download an applet containing this pattern, and create a base image, etc. from the pattern.

Furthermore, the user can add a message to the image by writing characters by hand or entering characters from a keyboard. In this case, the handwritten characters are created as parameterized characters in the same manner that the image is parameterized.

The user can transmit the thus created image and message in the form of a card electronically or by ordinary mail. When sending the card electronically, the user can specify the recipient's name and address as well as the desired date of reception. When sending it by ordinary post, the user can send the card in a printed form with a scent added to it.

Since the image and characters are parameterized for transmission, the burdens of the network and the local terminals are reduced. When sending the card electronically, the card is in digital form, and the recipient is notified by electronic mail that the card is waiting to be picked up at the specified site. The recipient can receive this card by entering an access number and password necessary to view the electronic version of the card.

### BRIEF DESCRIPTION OF DRAWINGS

FIG. 1 is a simplified block diagram showing a system configuration where the present invention is applied to a card system;

FIG. 2 is a flowchart illustrating the procedure for a method for creating an image, etc. and a method for transmitting the image according to the present invention;

FIG. 3 is a flowchart illustrating the procedure for another method for creating an image, etc. and a method for transmitting the same according to the present invention;

FIG. 4 is a diagram showing a Web page of a JAVA application card system;

FIG. 5 is a diagram showing a screen displayed by clicking on icon 1 (design) in FIG. 4;

FIG. 6 is a diagram showing a screen displaying a slimmed version of the image shown in FIG. 5;

FIG. 7 is a diagram showing a screen display when a style icon with a single orchid, at the left edge of the screen, is selected after clicking on the icon 2 (style) in FIG. 4;

FIG. 8 is a diagram showing a screen display when a style icon with orderly arranged images, at the left edge of the screen, is selected after clicking on the icon 2 (style);

FIG. 9 is a diagram showing a screen display when a style icon with randomly arranged images, at the left edge of the screen, is selected after clicking on the icon 2 (style);

FIG. 10 is a diagram showing a screen display when a style icon with images arranged in a heart shape, at the left edge of the screen, is selected after clicking on the icon 2 (style);

FIG. 11 is a diagram showing a screen display when a style icon with a bursting image, at the left edge of the screen, is selected after clicking on the icon 2 (style);

FIG. 12 is a diagram showing a screen display when a style icon with a swirling image, at the left edge of the screen, is selected after clicking on the icon 2 (style);

FIG. 13 is a diagram showing a screen when a free style icon at the left edge of the screen is selected after clicking on the icon 2 (style) and an image “YS” is drawn by clicking on the screen;

FIG. 14 is a diagram showing a screen when “Text” on the screen displayed by clicking on the icon 3 is clicked and a message is entered from a keyboard;

FIG. 15 is a diagram showing a screen displayed by clicking “Draw” and on which handwritten characters and lines are drawn;

FIG. 16 is a diagram showing a screen displayed by clicking on an icon 4 (Send);

FIG. 17 is a diagram showing a screen for confirming the addressee and date of transmission displayed by clicking on “E-mail” on the screen of FIG. 16;

FIG. 18 is a diagram displaying the contents of E-mail delivered to the addressee of a card;

FIG. 19 is a diagram showing a screen display when “View card” is clicked;

FIG. 20 is a diagram showing a card created by printing out a parameterized image together with a message;

FIG. 21 is a diagram showing a female face classified into nine face patterns whose data are digitized and expressed by parametric curves and solid colors;

FIG. 22 is a diagram showing a standard face (in the middle of FIG. 21) selected from among the face patterns shown in FIG. 21;

FIG. 23 is a diagram showing a childish face (in the upper left corner of FIG. 21) selected from among the face patterns shown in FIG. 21;

FIG. 24 is a diagram showing an intermediate face created from the faces shown in FIGS. 22 and 23;

FIG. 25 is a diagram showing a hair style and garment that are digitized and expressed by parametric curves;

FIG. 26 is a diagram showing the hair style and garment that are changed by controlling the parametric curves; and

FIG. 27 is a diagram showing the hair style and garment that are changed by controlling the parametric curves.

### DETAILED DESCRIPTION OF THE INVENTION

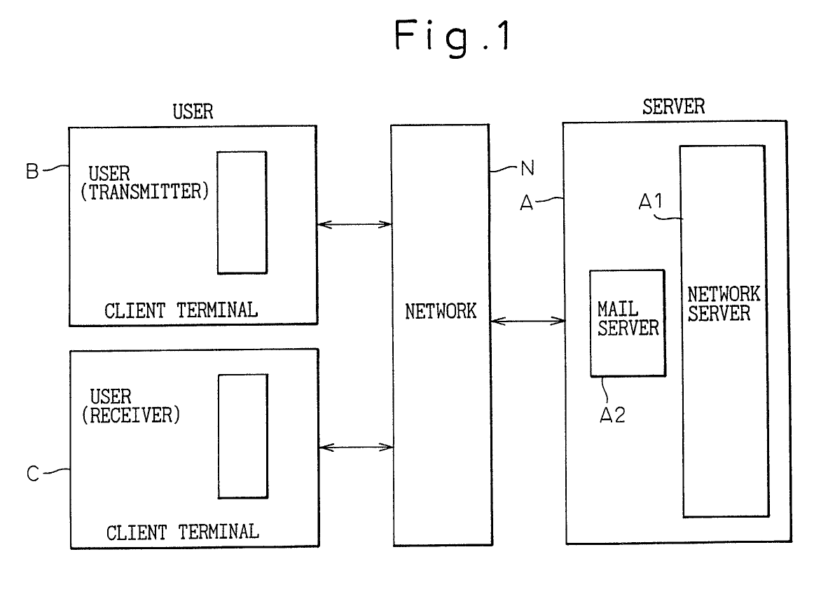

FIG. 1 is a simplified block diagram showing a system configuration where the present invention is applied to a card system. Reference character A is a server which includes a network server A1 and a mail server A2. B is a client terminal located at the transmitting user, and C is a client terminal at the receiving user. The client terminals B and C are connected to the server A by a network A such as a LAN or the Internet.

The above system configuration will be described for the case in which the transmitting user creates a card consisting of an image, handwritten characters, etc. and transmits this card to another user, i.e., the receiving user, over the network.

First, the transmitting user downloads a JAVA applet from the server A into the client terminal B via the network N. This applet has a function with which the user can create an image, etc. by controlling parametric curves. Next, the transmitting user creates a desired image, etc. by controlling the parametric curves on the network using the JAVA language on this applet. The transmitting user converts the created image, etc. into a card form and transmits the card to the server A. The network server A1 in the server A transmits the card to the receiving client terminal C via the mail server A2 and over the network N. At this time, a mail message notifying the arrival of the card is sent to the receiving user, and when the user enters the ID and password provided in the mail message, the contents of the card are displayed on the client terminal C.

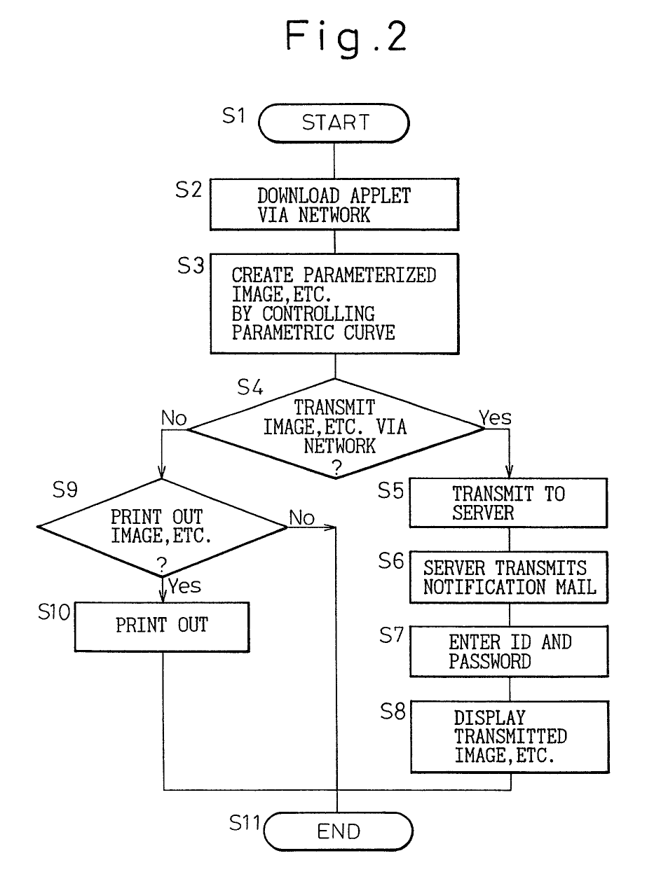

FIG. 2 is a flowchart illustrating a method for creating an image, etc. and a method for transmitting the image according to the present invention. First, the client terminal B is put into operation (S1). Next, the transmitting user downloads a JAVA applet from the server A into the client terminal B via the network N (S2). This applet has a function with which the user can create an image, line drawing, and character by controlling parametric curves. The transmitting user creates a desired image, line drawing, and character by controlling the parametric curves on the network using the JAVA language on this applet (S3). The user then creates a card using the image, line drawing, and character he created. In this case, the format need not necessarily be limited to a card. Next, the user decides whether the thus created card should be transmitted to the receiving user over the network (S4). If it is to be transmitted over the network (Yes), the transmitting user transmits the card to the server A (S5). The network server A1 in the server A sends a mail message to the receiving client server C via the mail server A2 to notify the arrival of the card (S6). When the receiving user enters the ID and password provided in the mail message (S7), the contents of the card are displayed on the client terminal C (S8).

If it is decided in S4 that the card is not to be transmitted over the network, then the user decides if the image, etc. should be printed out (S9). If so (Yes), the process proceeds to S10 to print out the card. If it is not to be printed out (No), the process proceeds to END (S11).

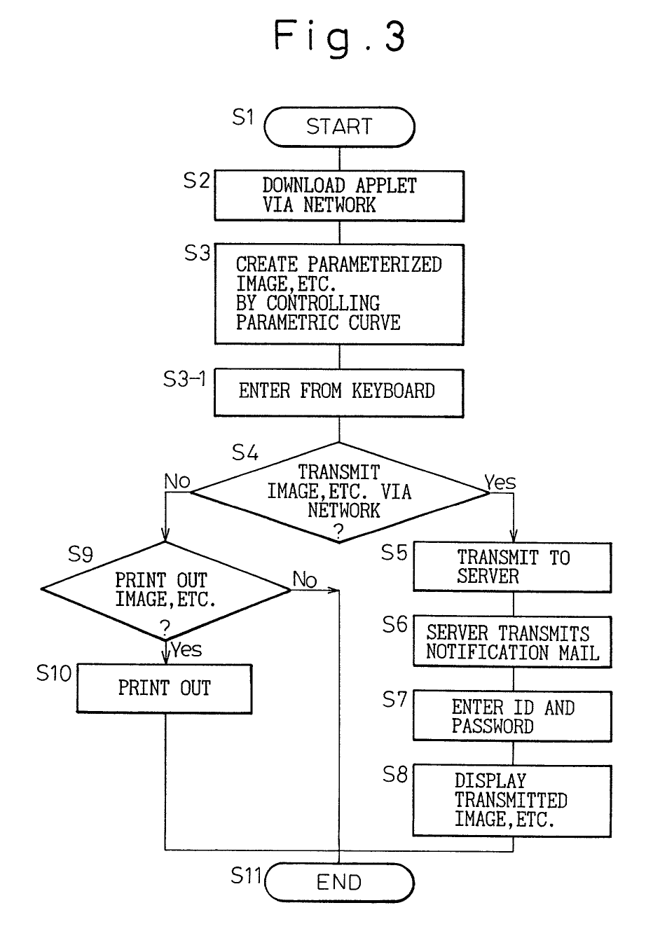

FIG. 3 is a flowchart illustrating another method for creating an image, etc. and a method for transmitting the same according to the present invention. The difference from the flowchart of FIG. 2 is that S3-1 is included between S3 and S4. In S3, the user creates a desired image, line drawing, and character by controlling the parametric curves on the network using the JAVA language on the downloaded applet. In the flowchart of FIG. 3, characters, symbols, etc. are entered from a keyboard (S3-1), which are then added to the image, etc. created by controlling the parametric curves and are transmitted or printed out together. The flowchart from S4 onward is therefore the same as the flowchart of FIG. 2.

Next, an embodiment of the present invention will be described in which an image, etc. are created by controlling the parametric curves using the JAVA language, by taking Cyber Orchid, a JAVA application card system, as an example.

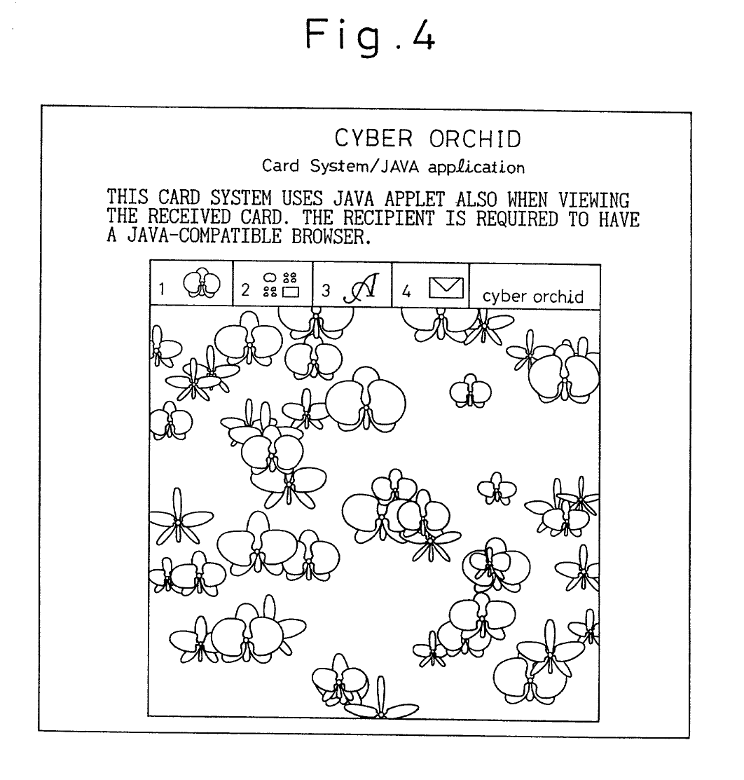

First, the transmitting user downloads an applet for Cyber Orchid from the server A into the client terminal B via the Internet. This applet has a function with which the user can create an image, etc. by controlling parametric curves. When this applet is downloaded, the Cyber Orchid Web page shown in FIG. 4 is displayed on the screen of the client terminal B, with card creation icons displayed at the top of the page. In FIG. 4, reference numeral 1 is a design icon, which is used to select a design for an image and to fine tune the design by varying the shape and color of the image. Reference numeral 2 is a style icon, which is used to select an algorithm style for the image selected by the icon 1. In the illustrated example, seven algorithm styles are available for selection. Reference numeral 3 is a greeting icon, which is used to create a message, etc. Reference numeral 4 is a send icon, which is used to send the card to the specified recipient on the specified date.

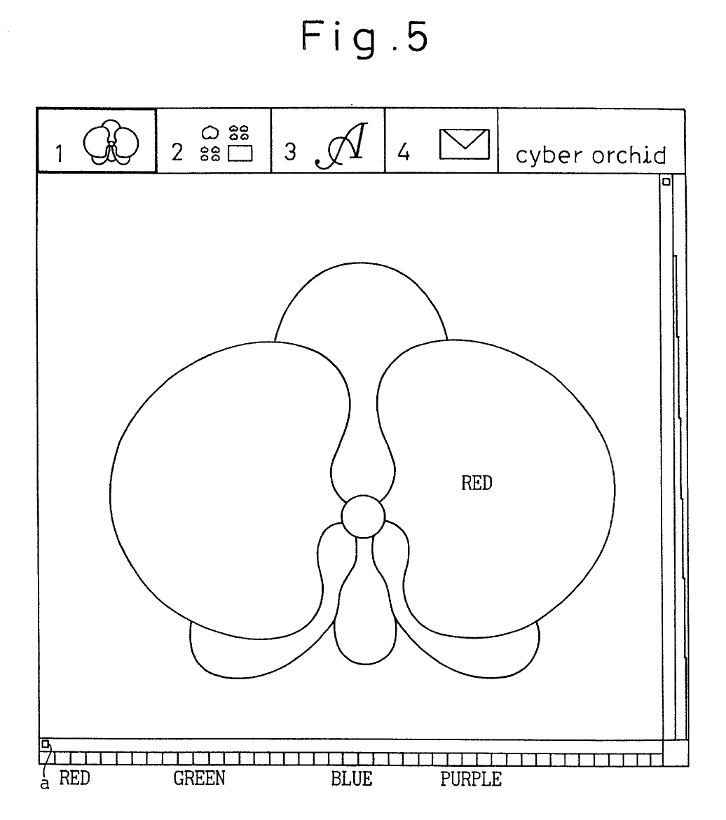

A method of creating an image, etc. by controlling parametric curves will be described below. When the user clicks on the icon 1, an orchid is displayed on the screen, as shown in FIG. 5. At the bottom of the screen is displayed a bar of selectable colors. In the screen shown here, mark “a” for color selection is at the position of red at the left edge of the color bar, so that the orchid is displayed in red. When the mark “a” is moved to the center of the bar, the color of the orchid changes to blue. The image color can thus be changed as desired.

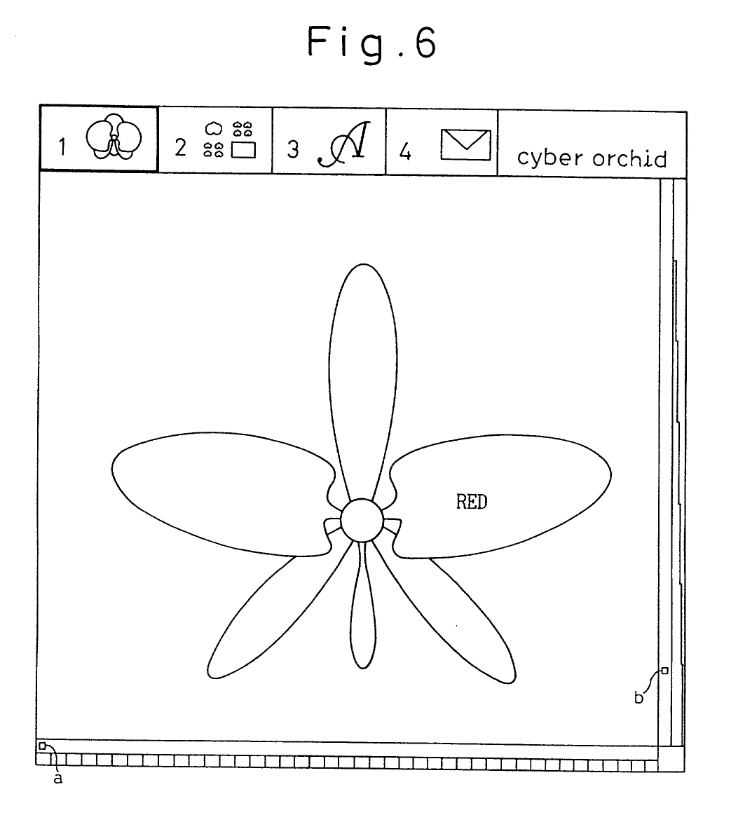

To change the image shape, mark “b” for shape selection, at the right edge of the screen, is moved up or down. FIG. 6 shows the condition in which the mark “b” is moved downward so that the orchid is displayed in a slim shape. In FIG. 6, the mark “a” is positioned at the left edge to display the orchid in red.

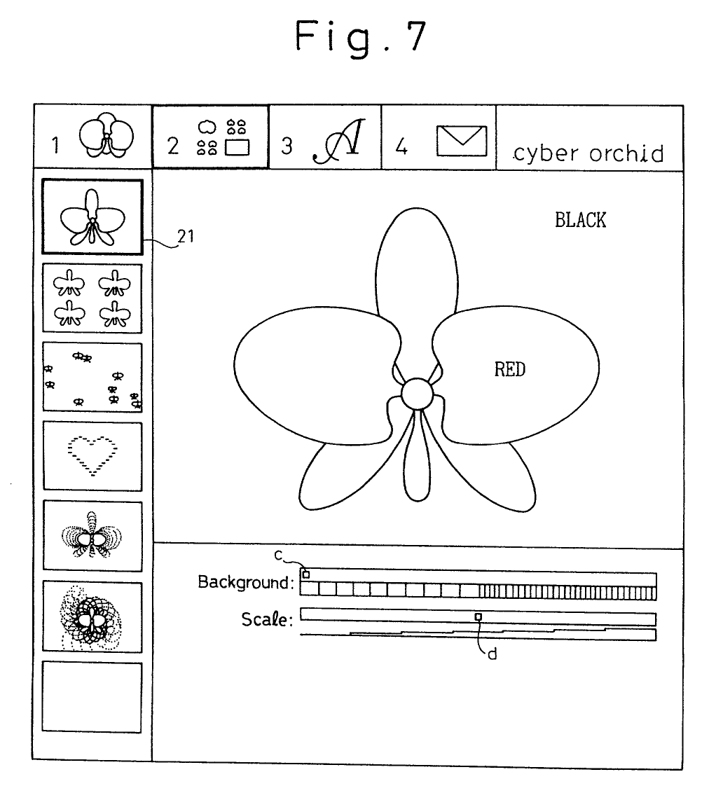

When the user clicks on the icon 2, the screen shown in FIG. 7 is displayed, and the user can select his desired style from among the seven styles displayed at the left edge of the screen. In the illustrated example, style icon 21 is selected that specifies the number of orchids, in this case, one. The screen also provides a selection of background color (Background) and scale (Scale). In FIG. 7, mark “c” for selection of the background color is at the position of black, and mark “d” for selection of the scale is at the center of the scale. To change the background color, the mark “c” for selection of the background color is moved.

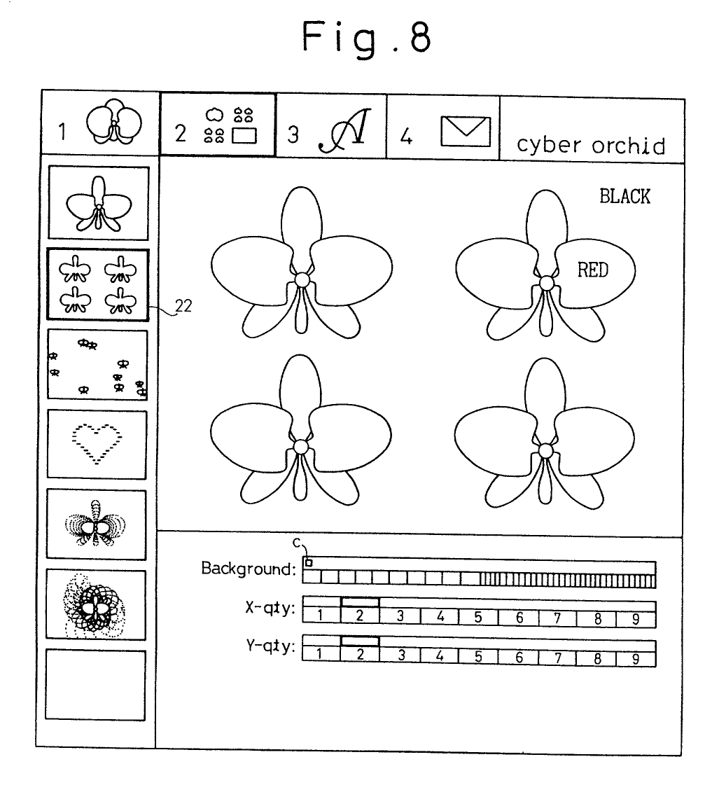

When style icon 22 with orderly arranged orchids, at the left edge of the screen, is selected after clicking on the icon 2, the screen shown in FIG. 8 appears. In this screen, the number of orchids (x−qty) per row and the number of orchids (y−qty) per column are displayed, to allow the numbers to be changed.

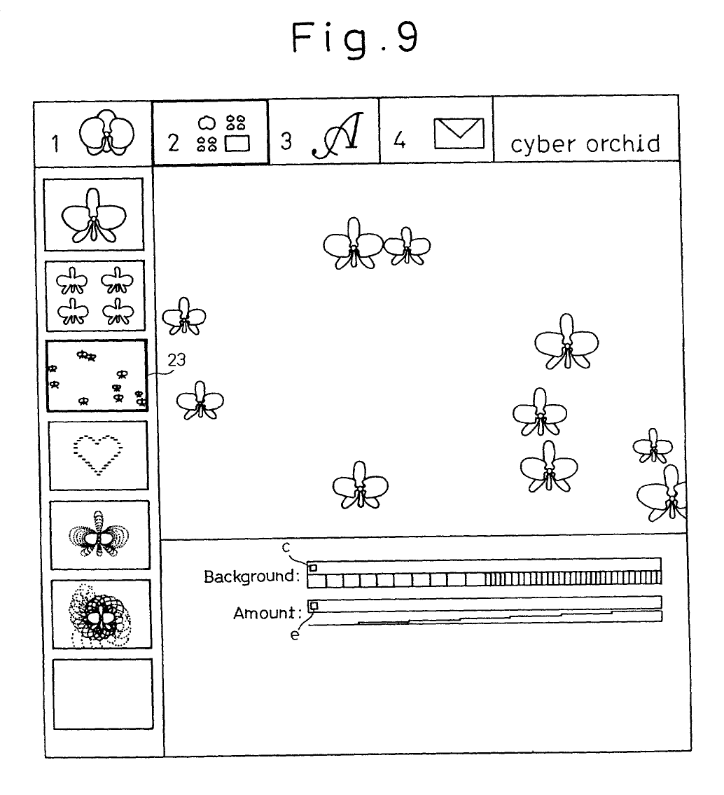

When style icon 23 with randomly arranged orchids, at the left edge of the screen, is selected after clicking on the icon 2, the screen shown in FIG. 9 appears. In this screen, mark “e” for selection of orchid amount (Amount) is displayed so that the amount can be changed.

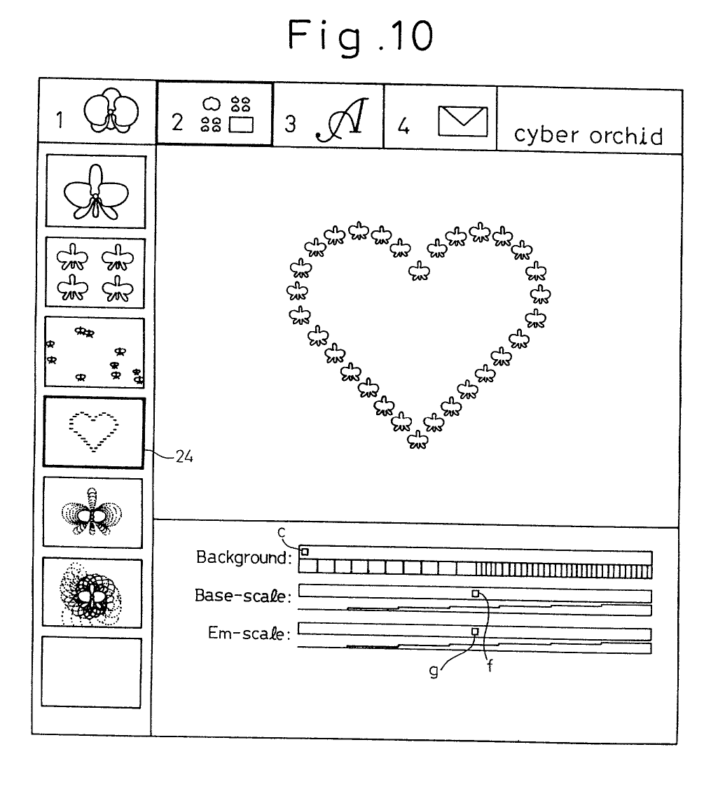

When style icon 24 with orchids arranged in a heart shape, at the left edge of the screen, is selected after clicking on the icon 2, the screen shown in FIG. 10 appears. In this screen, mark “f” for selecting the scale (Base-scale) of the heart shape as the base image and mark “g” for selecting the scale (Em-scale) of each individual orchid forming the heart shape are displayed so that these scale factors can be changed.

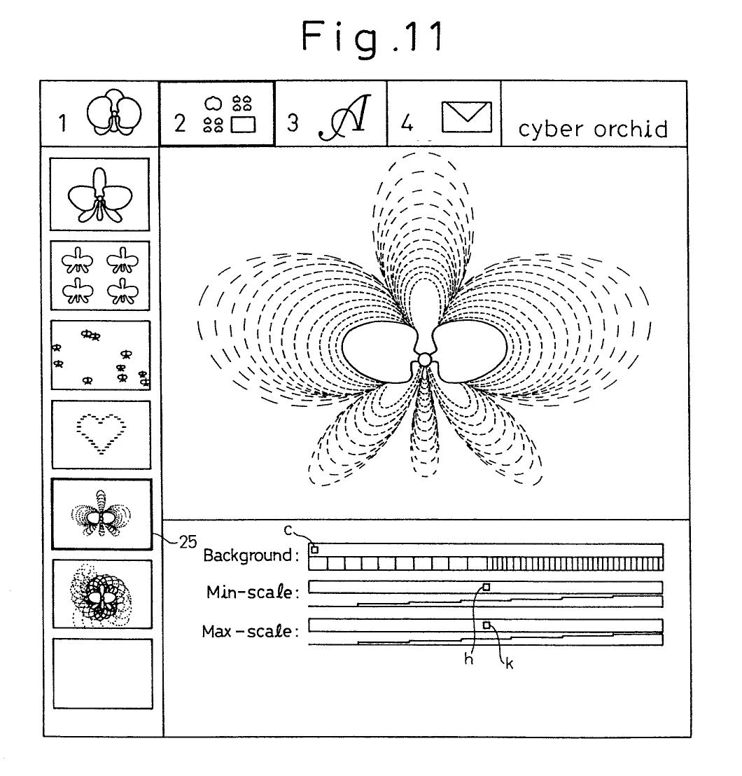

When style icon 25 with a bursting orchid, at the left edge of the screen, is selected after clicking on the icon 2, the screen shown in FIG. 11 appears. In this screen, mark “h” for selecting the scale (Min-scale) of the center portion of the orchid and mark “k” for selecting the scale (Max-scale) of the outer portion of the burst are displayed so that these scale factors can be changed.

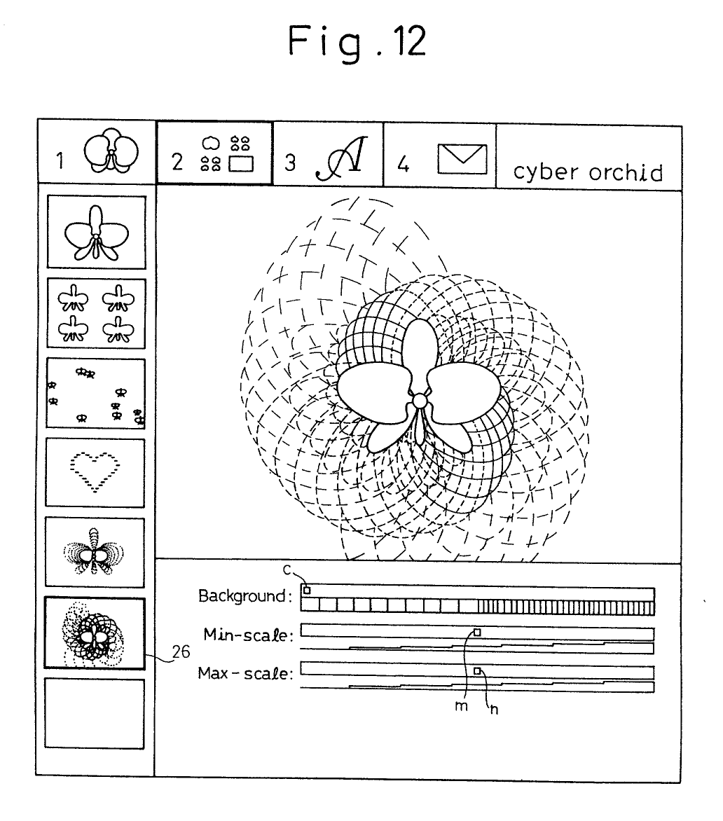

When style icon 26 with a swirling orchid, at the left edge of the screen, is selected after clicking on the icon 2, the screen shown in FIG. 12 appears. In this screen, mark “m” for selecting the scale (Min-scale) of the center portion of the orchid and mark “n” for selecting the scale (Max-scale) of the outer portion of the swirl are displayed so that these scale factors can be changed.

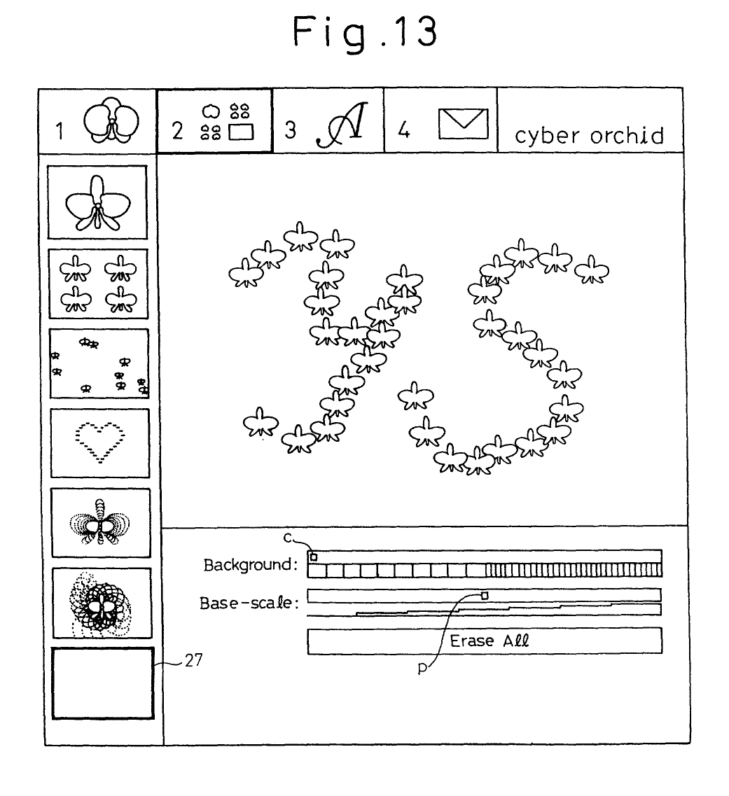

When a free style icon 27 at the bottom left corner of the screen is selected after clicking on the icon 2, and a mouse is moved into the upper left area of the screen and clicked on a desired location, an orchid appears on the screen. By repeating this operation by moving around the mouse, a desired shape can be formed with orchids. FIG. 13 shows a screen on which “YS” is drawn with orchids formed in the above manner. This screen also allows the size (Base-scale) of each orchid to be changed by moving mark “p”.

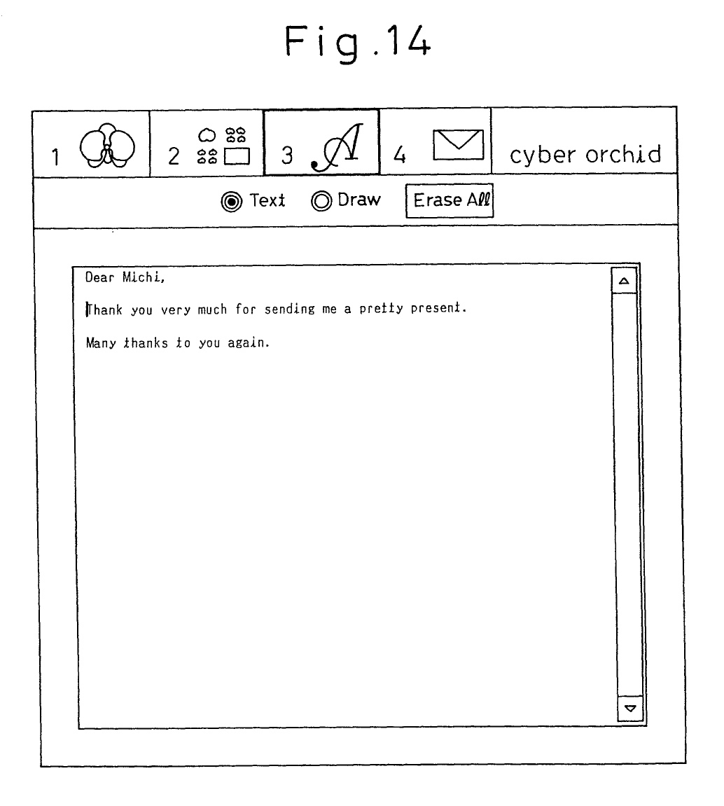

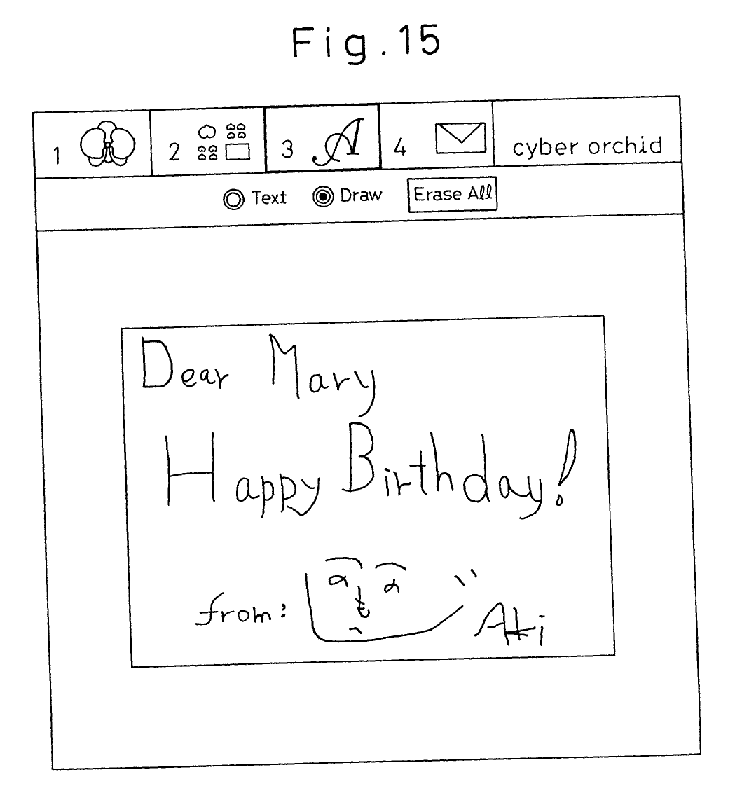

When the user clicks on icon 3, a blank screen appears on which the user can enter characters from the keyboard or draw characters or a picture by hand. When the use clicks on “Text” in the upper part of the screen, keyboard character entry is enabled, allowing the user to enter a message, as shown in FIG. 14. When the user clicks on “Draw”, the user can draw characters and lines freely, as shown in FIG. 15.

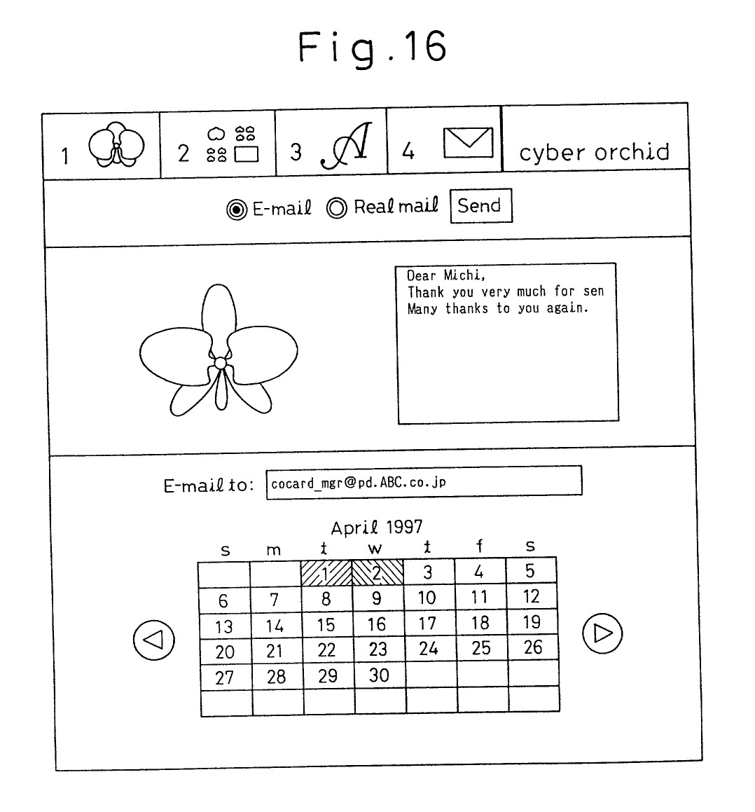

When the user clicks on icon 4, the screen shown in FIG. 16 appears, where an image (in this example, one red orchid) selected for the card from among the previously created images is displayed at the upper left part and a message (in this example, text entered from the keyboard) at the upper right part. In the lower part of the screen are displayed a box in which the E-mail addressee is entered and a calender used to set the date of transmission. The user clicks on “E-mail” in the upper part of the screen and selects the date of receipt of the card (April 1st).

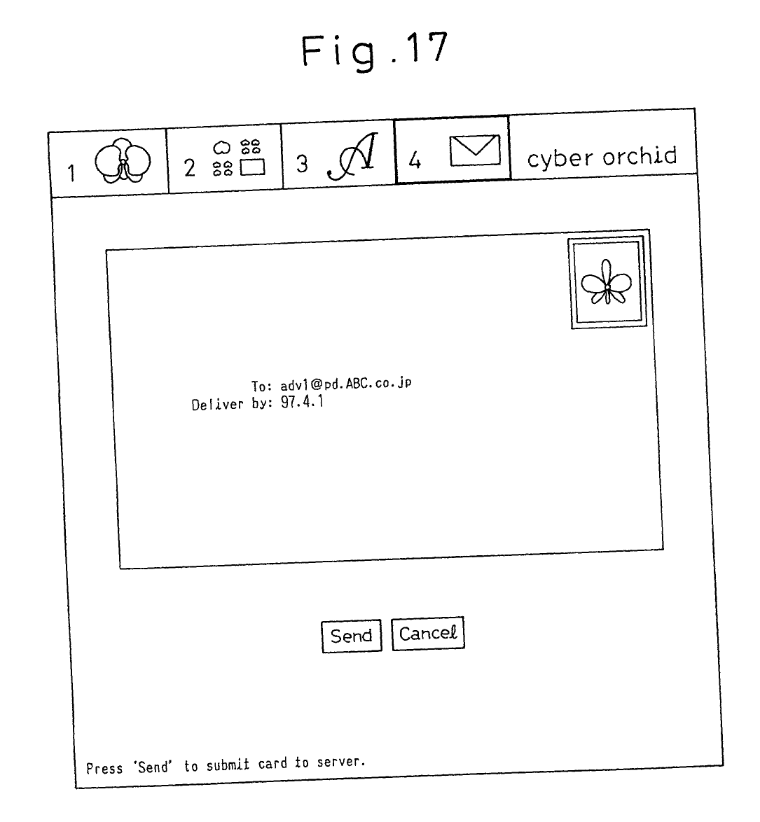

When the user clicks on “E-mail”, a screen appears on which the user checks if the addressee and the date of transmission are correct (FIG. 17); if they are correct, the user clicks on “Send”.

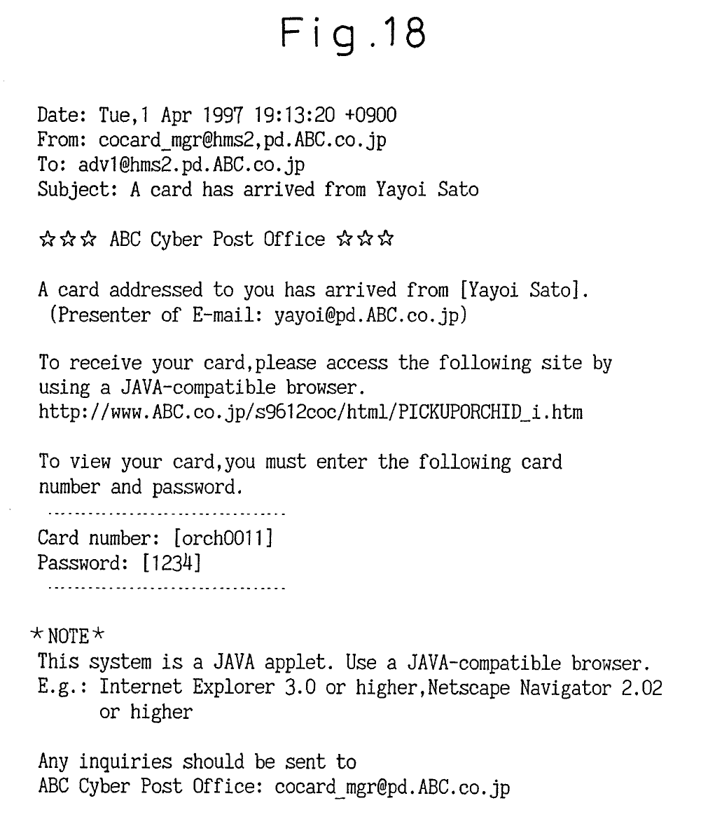

FIG. 18 shows the contents of the E-mail delivered to the addressee of the card, notifying the arrival of the card, the name of the card sender, the URL to access to receive the card, and the card number and password necessary to receive the card.

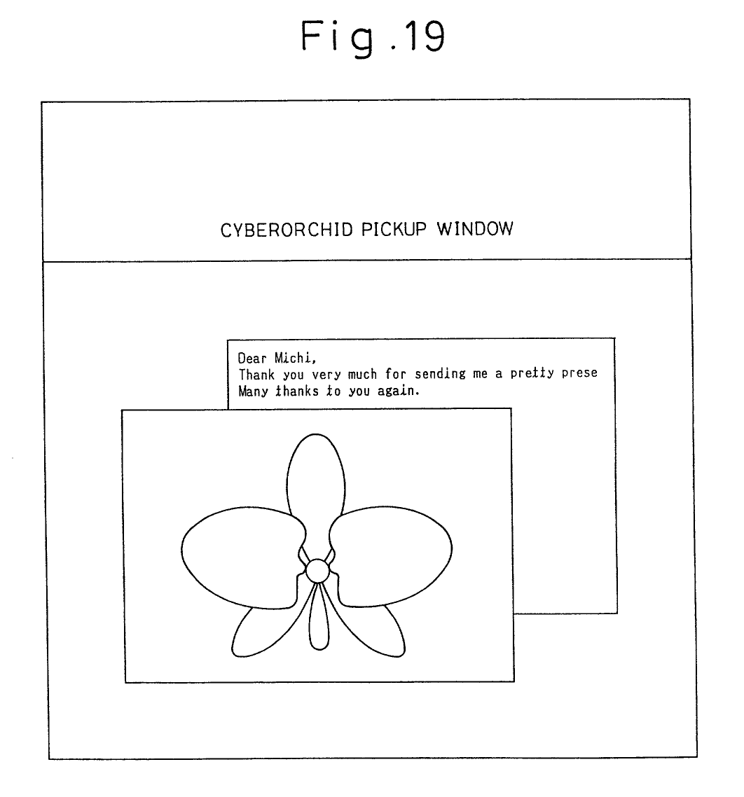

The recipient of the card who reads this mail accesses the specified URL, enters the card number and password, and clicks on “View card”, upon which the screen shown in FIG. 19 appears with a message. On this screen, the message display is partially occluded behind the image display. When the message is selected, the message display is brought to the foreground.

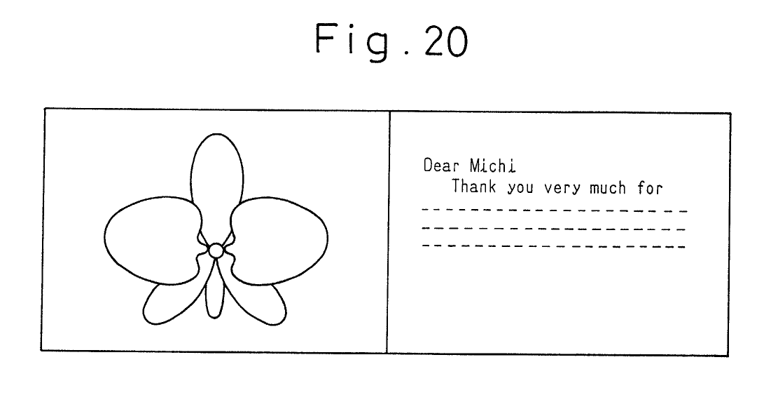

FIG. 19 shows the case in which the card is sent to the recipient by E-mail, but it is also possible to print out the image and message, create a card such as shown in FIG. 20, and send it to the recipient by ordinary mail.

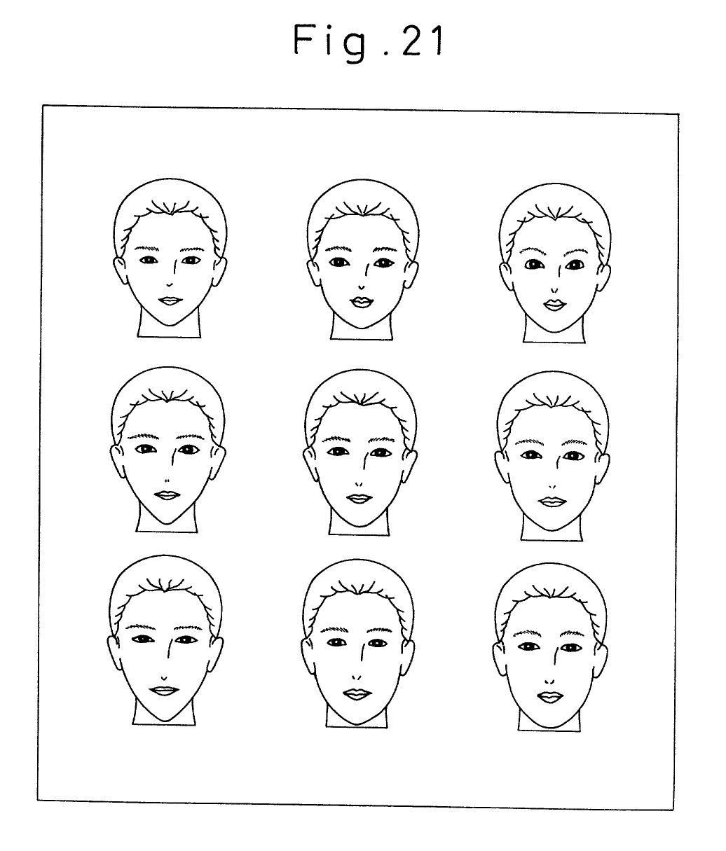

Next, a description will be given of an embodiment in which the present invention is applied in order to change the shape of a human face. In this embodiment, the human face is classified into several types, and these faces are expressed by parametric curves; then, by varying the parameters, subtle changes are applied to the human face. This embodiment will be described below with reference to FIGS. 21 to 24. The method of changing the shape of the face is essentially the same as that employed for the “Orchid” described above, and therefore, details of the method will not be given here.

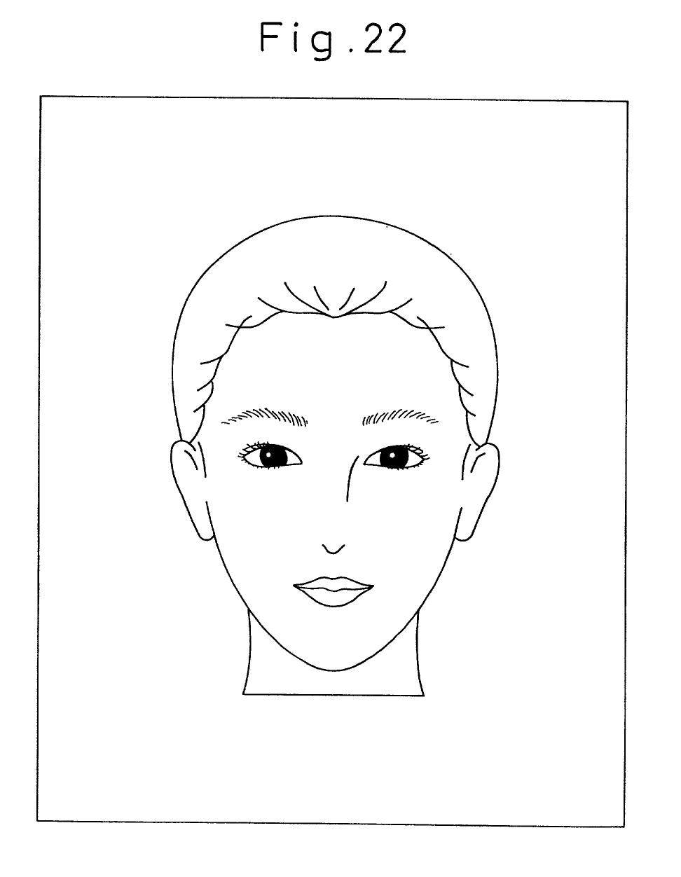

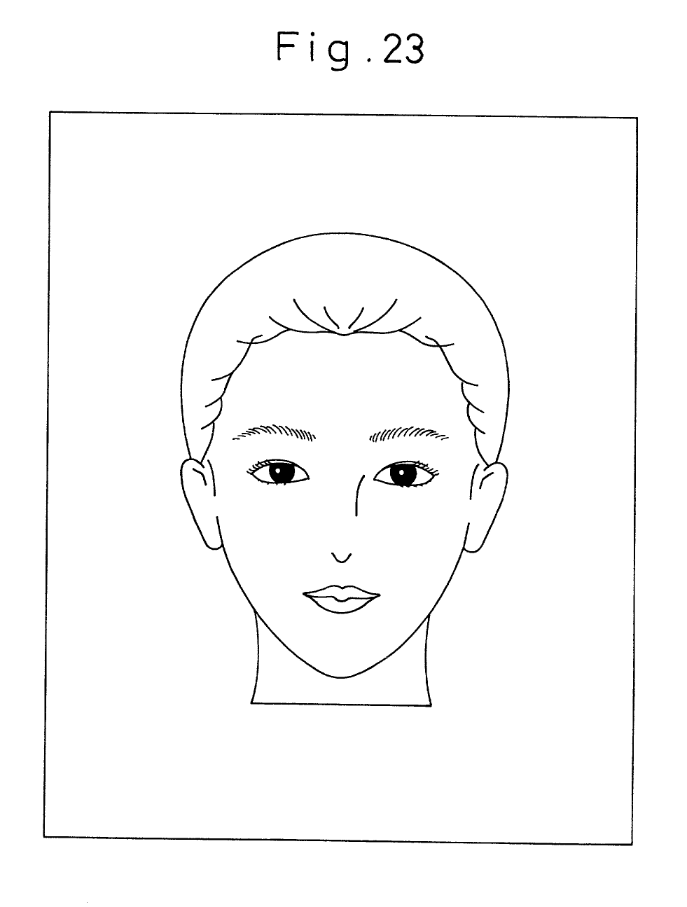

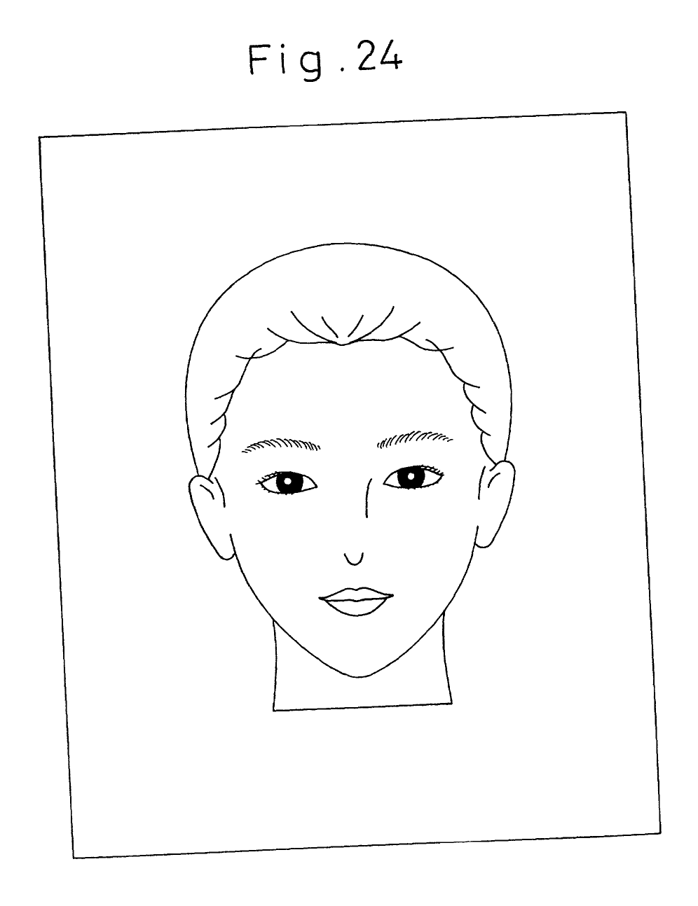

In FIG. 21, a female face is classified into nine patterns, and data of these faces are digitized and expressed by parametric curves and solid colors. FIG. 22 shows a standard face (the face in the middle of FIG. 21) selected from among the nine patterns. FIG. 23 shows a childish face (the face in the upper left corner of FIG. 21) selected from among the nine patterns. The faces shown in FIGS. 22 and 23 are both expressed by parametric curves; by calculating values intermediate between the parameters of the faces of FIGS. 22 and 23, it is possible to create a face that falls in between the “standard face” and the “childish face”, as shown in FIG. 24. It is also possible to apply, for example, changes to the standard face and create a desired face or a face of the shape and color resembling a specific user.

In that case also, a message including advice can be created by hand or by using a keyboard and can be sent to the recipient together with the face created as described above.

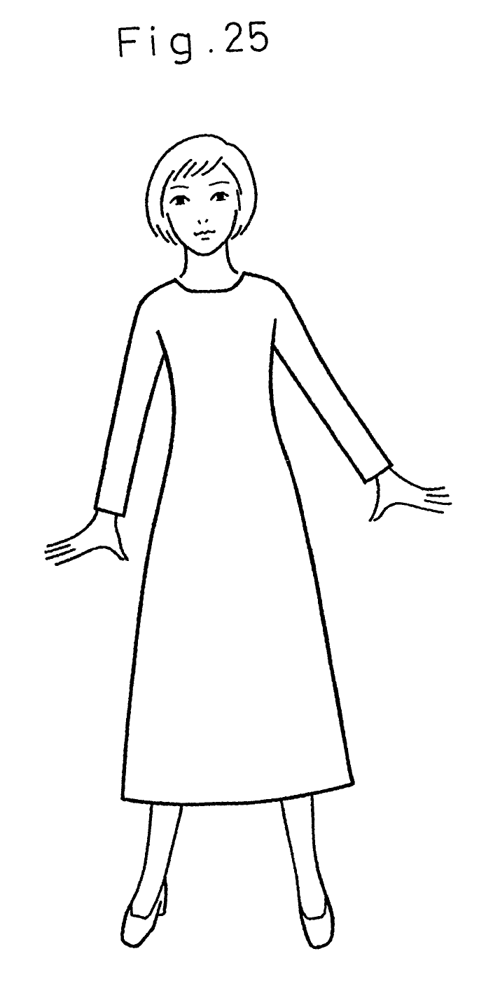

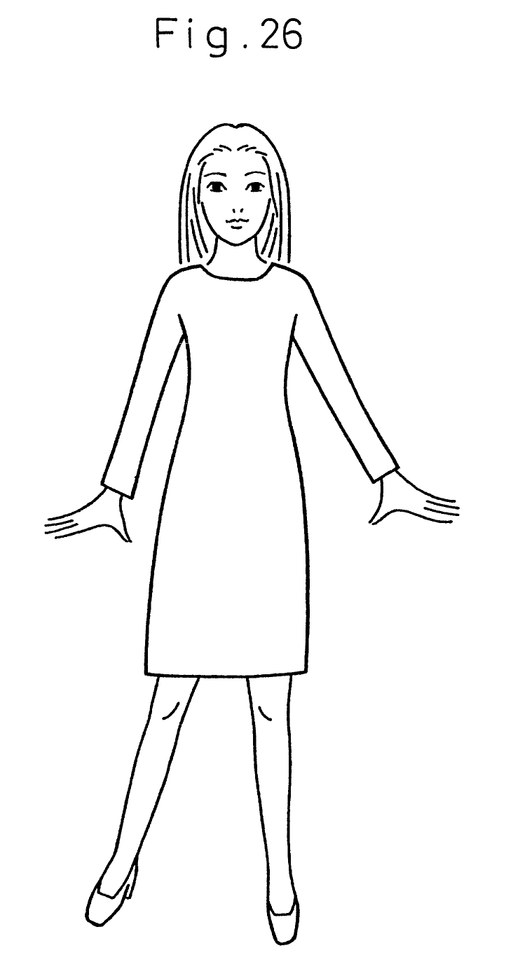

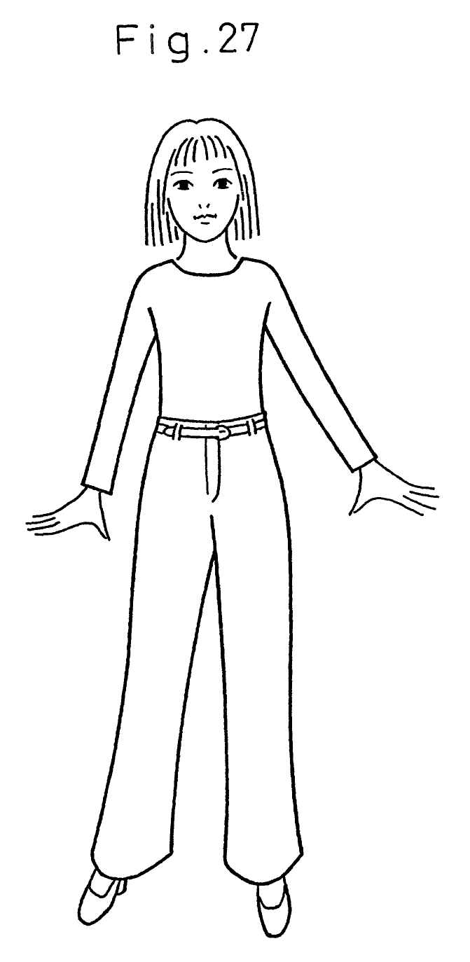

Next, a description will be given of an embodiment in which the present invention is applied in order to change the hair style or clothing of a human. As shown in FIGS. 25 to 27, the hair style or the clothing is expressed by parametric curves and, by varying the parameters, the user can select and create his desired hair style or clothing. In FIGS. 25 to 27, compared with the base image of FIG. 25 with a short hair style and one-piece dress, the hair style in FIG. 26 is made semi-long and the dress is shortened. In FIG. 27, the hair style is changed and the dress is changed to a shirt and pants. In this embodiment also, the method of changing the hair style or garment is essentially the same as that employed for the “Orchid” described earlier, and therefore, details of the method will not be given here. In the above figures, the hair style and garment are drawn, but it is also possible to select accessories, colors, quality of the garment, etc. and create a total fashion look.

Each of the above embodiments has dealt with the case where images, etc. are created by controlling parametric curves, or where patterns of parameterized image, etc. are created in advance by controlling parametric curves and, based on such patterns, images, etc. are created.

However, in an alternative embodiment of the present invention, images, etc. can also be created in the following manner. First, the user captures an already created desired image, etc. into a computer in the network, and transmits it to the server over the network. The server converts the image into a parameterized pattern so that its shape can be changed by controlling a parametric curve. Then, an applet containing the parameterized pattern is downloaded and, based on this pattern, an image, etc. are created.

According to the present invention, a desired image or character or the like can be created by controlling a parametric curve using the JAVA language on the network and by creating a parameterized image, character, or line drawing. Further, since the shape, size, quantity, arrangement, orientation, and color of the created image or character or the like can be changed freely, the user can create a graphic or the like just as he desires.

Further, when transmitting the image, character, etc. over a network, since they are parameterized for transmission by controlling parametric curves, the amount of data is reduced, which serves to reduce the burden on the network and local terminals, compared with the prior art in which images are transmitted in encoded form.

1. A method for creating at least one of an image, a character, and a line drawing by a computer in a network, wherein an applet, created with the JAVA language and having a function with which at least one of said image, said character, and said line drawing can be created by controlling a parametric curve, is downloaded from a server into a client terminal via a network, and at least one of a parameterized image, a parameterized character, and a parameterized line drawing is created interactively by controlling said parametric curve using said downloaded applet.

2. A method as claimed in claim 1, wherein said applet has a plurality of patterns created by parameterizing at least one of said image, said character, and said line drawing by controlling said parametric curve, and at least one of said parameterized image, said parameterized character, and said parameterized line drawing is created interactively by selecting a motif from said plurality of patterns and by controlling said parametric curve.

3. A method as claimed in claim 1, wherein said applet contains at least one of a desired image, a desired character, and a desired line drawing, which a user has transmitted to said server over the Internet, in the form of a pattern parameterized by controlling said parametric curve using the JAVA language, and at least one of said image, said character, and said line drawing is created from said pattern.

4. A method as claimed in claim 1, 2, or 3, wherein at least one of said image, said character, and said line drawing is created by varying at least one of its shape, size, quantity, arrangement, orientation, and color by controlling said parametric curve.

5. A method as claimed in claim 1, 2, or 3, wherein said parametric curve is a Bezier curve.

6. A method as claimed in claim 1, 2, or 3, wherein said parameterized image or said parameterized line drawing is a human face.

7. A method as claimed in claim 1, 2, or 3, wherein said parameterized image or said parameterized line drawing is at least one of a hair style, a garment, an accessory, and a color.

8. A method for creating a card by printing out at least one of said image, said character, and said line drawing created by the method as claimed in claim 1, 2, or 3.

9. A method for creating a card by printing out a character, entered from a keyboard, together with at least one of said image, said character, and said line drawing created by the method as claimed in claim 1, 2, or 3.

10. A method for creating and transmitting at least one of an image, a character, and a line drawing by a computer in a network, wherein an applet, created with the JAVA language and having a function with which at least one of an image, a character, and a line drawing can be created by controlling a parametric curve, is downloaded from a server into a client terminal via a network, at least one of a parameterized image, a parameterized character, and a parameterized line drawing is created interactively by controlling said parametric curve using said downloaded applet, and at least one of said created image, character, and line drawing is transmitted over a network.

11. A method of image, character, and line drawing transmission as claimed in claim 10, wherein a character entered from a keyboard is transmitted together with at least one of said parameterized image, said parameterized character, and said parameterized line drawing.
